(19) United States
(12) Patent Application Publication
(10) Pub. No.: US 2023/0051369 A1
(43) Pub. Date: Feb. 16, 2023

(54) APPARATUS FOR OPERATING OVER-THE-AIR OTA UPDATE FOR VEHICLE, AND METHOD THEREOF

(71) Applicants: Hyundai Motor Company, Seoul (KR); Kia Corporation, Seoul (KR)

(72) Inventors: Hyeok Sang Jeong, Hwaseong (KR); Myeong Gyu Jeong, Seoul (KR); Jin Ah Kim, Hwaseong (KR); Yoon Sik Jung, Seoul (KR); Hak Jun Kim, Goyang (KR); Dong Youl Lee, Seoul (KR); Young Jee Yang, Seongnam (KR)

(21) Appl. No.: 17/752,967

(22) Filed: May 25, 2022

(30) Foreign Application Priority Data
Aug. 13, 2021 (KR) 10-2021-0107199

(51) Int. Cl. G06F 8/65

(52) U.S. Cl. CPC G06F 8/65; B60W 50/00

(57) ABSTRACT

An apparatus for performing an OTA update for a vehicle includes a first collection device that collects first information about a controller to perform an OTA update process on the controller included in the vehicle, a second collection device that collects second information about the controller in response to the OTA update process being interrupted, a replacement information generation device that generates replacement information of the controller based on the collected first information and the collected second information, and a process execution device that performs either a process of resuming the OTA update or a process of initializing the OTA update previously performed on the controller based on the generated replacement information.

### CROSS-REFERENCE TO RELATED APPLICATION

This application claims under 35 U.S.C. § 119(a) the benefit of Korean Patent Application No. 10-2021-0107199, filed in the Korean Intellectual Property Office on Aug. 13, 2021, the entire contents of which are incorporated herein by reference.

### BACKGROUND

### (a) Technical Field

The present disclosure relates to an apparatus and method for operating an over-the-air (OTA) update for a vehicle.

### (b) Description of the Related Art

In general, OTA updates for controllers included in a vehicle may be interrupted for various reasons (e.g., the ignition of the vehicle is powered off). The OTA updates that have been interrupted may be resumed for other reasons (e.g., the ignition of the vehicle is powered on). As such, the interrupted OTA updates may be resumed. In this case, when it is not determined whether a corresponding controller is replaced, an incorrect OTA update may be performed.

Furthermore, as described above, it may be determined that the corresponding controller has been replaced. In such a case, an incorrect OTA update may be performed when a previously-performed OTA update is not initialized and then a new OTA update is not performed.

### SUMMARY

An aspect of the present disclosure provides an apparatus capable of determining whether a controller to be updated is replaced, when an interrupted OTA update is resumed, and a method thereof.

Furthermore, an aspect of the present disclosure provides an apparatus capable of initializing a previously-performed OTA update, when it is determined that the controller that is a target of an OTA update has been replaced, in resuming the interrupted OTA update, and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for performing an OTA update for a vehicle may include a first collection device that collects first information about a controller to perform an OTA update process on the controller included in the vehicle, a second collection device that collects second information about the controller in response to interruption of the OTA update process, a replacement information generation device that generates replacement information of the controller based on the collected first information and the collected second information, and a process execution device that performs either a process of resuming the OTA update or a process of initializing the OTA update previously performed on the controller based on the generated replacement information.

Furthermore, according to embodiments, the first information may be collected in a first period. The second information may be collected in a second period. The first period may precede the second period.

Moreover, according to embodiments, the OTA update process may be interrupted in response to powering off an ignition of the vehicle.

Also, according to embodiments, the second information may be collected in response to interruption of the OTA update process and powering off an ignition of the vehicle.

Besides, according to embodiments, the first information may include at least one of first VIN information collected in the first period or first software version information collected in the first period. The second information may include at least one of second VIN information collected in the second period or second software version information collected in the second period.

In addition, according to embodiments, the generated replacement information may include either information indicating that the controller has been replaced or information indicating that the controller has not been replaced.

Furthermore, according to embodiments, the process execution device may perform a process of initializing the OTA update previously performed on the controller in response to the generated replacement information including information indicating that the controller has been replaced, and performs a process of resuming the OTA update on the controller in response to the generated replacement information including information indicating that the controller has not been replaced.

Moreover, according to embodiments, the controller may indicate one of a first controller or a second controller.

Also, according to embodiments, replacement information of the first controller may be generated based on the first VIN information and the second VIN information. Replacement information of the second controller may be generated based on the first software version information and the second software version information.

Besides, according to embodiments, the generated replacement information may include information indicating that the controller has not been replaced, in response to the first information being identical to the second information, and may include information indicating that the controller has been replaced, in response to the first information being different from the second information.

According to an aspect of the present disclosure, a method for performing an OTA update for a vehicle may include collecting first information about a controller to perform an OTA update process on the controller included in the vehicle, collecting second information about the controller in response to interruption of the OTA update process, generating replacement information of the controller based on the collected first information and the collected second information, and performing either a process of resuming the OTA update or a process of initializing the OTA update previously performed on the controller based on the generated replacement information.

Furthermore, according to embodiments, the first information may be collected in a first period. The second information may be collected in a second period. The first period may precede the second period.

Moreover, according to embodiments, the OTA update process may be interrupted in response to powering off an ignition of the vehicle.

Also, according to embodiments, the second information may be collected in response to interruption of the OTA update process and powering off an ignition of the vehicle.

Besides, according to embodiments, the first information may include at least one of first VIN information collected in the first period or first software version information collected in the first period. The second information may include at least one of second VIN information collected in the second period or second software version information collected in the second period.

In addition, according to embodiments, the generated replacement information may include either information indicating that the controller has been replaced or information indicating that the controller has not been replaced.

Furthermore, according to embodiments, the performing of either the process of resuming the OTA update or the process of initializing the OTA update previously performed on the controller may include performing a process of initializing the OTA update previously performed on the controller in response to the generated replacement information including information indicating that the controller has been replaced and performing a process of resuming the OTA update on the controller in response to the generated replacement information including information indicating that the controller has not been replaced.

Moreover, according to embodiments, the controller may indicate one of a first controller or a second controller.

Also, according to embodiments, replacement information of the first controller may be generated based on the first VIN information and the second VIN information. Replacement information of the second controller may be generated based on the first software version information and the second software version information.

Besides, according to embodiments, the generated replacement information may include information indicating that the controller has not been replaced, in response to the first information being identical to the second information, and may include information indicating that the controller has been replaced, in response to the first information being different from the second information.

### BRIEF DESCRIPTION OF THE DRAWINGS

The above and other objects, features and advantages of the present disclosure will be more apparent from the following detailed description taken in conjunction with the accompanying drawings:

FIG. 1 illustrates an example of an environment, in which an OTA update apparatus for a vehicle is operated, according to embodiments;

FIG. 2 illustrates an example of an OTA update apparatus for a vehicle, according to embodiments;

FIG. 3 illustrates an example of an OTA update performed by an OTA update apparatus for a vehicle, according to embodiments;

FIG. 4 illustrates an example of an OTA update method for a vehicle, according to embodiments; and

FIG. 5 illustrates an example of an OTA update method for a vehicle, according to embodiments.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to the accompanying drawings. In adding reference numerals to components of each drawing, it should be noted that the same components have the same reference numerals, although they are indicated on another drawing. In describing the embodiments of the present disclosure, detailed descriptions associated with well-known functions or configurations will be omitted when they may make subject matters of the present disclosure unnecessarily obscure.

In describing components of embodiments of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as having a meaning that is consistent with their meaning in the context of the present disclosure and the relevant art and will not be interpreted in an idealized or overly formal sense unless expressly so defined herein.

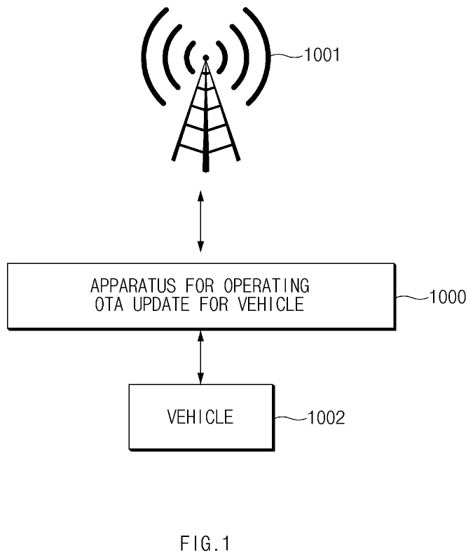

Hereinafter, various embodiments of the present disclosure will be described in detail with reference to FIGS. 1 to 5.

FIG. 1 illustrates an example of an environment, in which an OTA update apparatus 1000 (or an apparatus) for a vehicle according to embodiments is operated.

FIG. 1 illustrates that an apparatus is located outside a vehicle according to embodiments. However, the apparatus may also be located inside the vehicle.

A vehicle 1002 according to embodiments of the disclosure may include at least one of an electric vehicle (EV), a hybrid electric vehicle (HEV), or a plug-in hybrid electric vehicle (PHEV).

An OTA update according to embodiments may indicate a method for updating software of a vehicle over a wireless communication network. In general, software of a vehicle is executed by connecting a storage device, in which data for updating the software is stored, to the vehicle by wire. However, thanks to the development of communication technology, the vehicle may directly receive data required to update software over a wireless communication network and then may perform an update.

The apparatus according to embodiments may receive information (or data necessary for software update) for an OTA update from the server 1001. According to embodiments, the information for an OTA update may refer to information for performing the above-described OTA update. For example, the information for an OTA update includes software package information, software version information, or the like.

The apparatus according to embodiments may perform an OTA update of a vehicle based on information for an OTA update received from the server. That is, the apparatus may perform the OTA update by comparing information for an OTA update received from the server with information about vehicle software. For example, the apparatus may determine whether to perform an OTA update by comparing software version information received from the server with software version information of a controller included in a vehicle.

As described above, a vehicle according to embodiments may include one or more controllers. A controller according to embodiments may indicate a device that is included in a vehicle and performs a specific function. For example, the controller indicates an Electronic Control Unit (ECU) included in a vehicle.

The OTA update according to embodiments may be performed for each of the above-described controllers. That is, the OTA update performed by the apparatus may be independently performed for each controller or may be performed collectively for all controllers included in the vehicle.

The apparatus according to embodiments may wirelessly update software of controller(s) included in the vehicle through the OTA update described in FIG. 1. That is, the apparatus may update software of a controller in an OTA manner and then adding new functions of the controller, improving existing errors, and/or enhancing security may be performed.

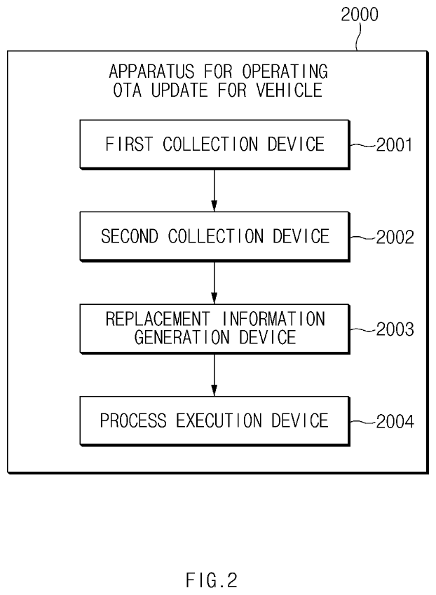

FIG. 2 illustrates an example of an OTA update apparatus 2000 (or an apparatus) for a vehicle, according to embodiments. The apparatus indicates the apparatus described above in FIG. 1.

In general, OTA updates for controllers included in a vehicle may be interrupted for various reasons (e.g., the ignition of the vehicle is powered off). The OTA updates that have interrupted for the controller may be resumed for other reasons (e.g., the ignition of the vehicle is powered on). As such, the interrupted OTA updates are resumed. In this case, when it is not determined whether the corresponding controller is replaced, an incorrect OTA update may be performed.

Furthermore, as described above, it is determined that the corresponding controller has been replaced, by determining whether the corresponding controller has been replaced. In this case, an incorrect OTA update may be performed when a previously-performed OTA update is not initialized and then a new OTA update is not performed.

In resuming the interrupted OTA update, the apparatus according to embodiments may determine whether a controller to be updated is replaced. The apparatus according to embodiments may initialize a previously-performed OTA update, when determining that the controller that is a target of an OTA update has been replaced, in resuming the interrupted OTA update.

The apparatus according to embodiments may include a first collection device 2001, a second collection device 2002, a replacement information generation device 2003, and/or a process execution device 2004. The apparatus according to embodiments may further include one or more elements not shown in FIG. 1.

The first collection device 2001 according to embodiments may collect first information about a controller to perform an OTA update process for a controller included in the vehicle.

As described above in FIG. 1, software package information of a controller or software version information of a controller may be required to perform an OTA update. The first information according to embodiments may be information for determining whether to perform the above-described OTA update. The first information may include at least one of vehicle identification number (VIN) information of the vehicle or software version information of the controller.

The apparatus according to embodiments may determine whether to perform an OTA update on the controller, based on the first information collected by the first collection device 2001. For example, the apparatus determines whether to perform an OTA update, based on the software version information of the controller.

However, as described above, the OTA update process for the controller may be interrupted. For example, an ongoing OTA update process may be interrupted in response to powering off the vehicle's ignition.

Afterward, the above-described OTA update process may be resumed or initialized in response to the fact that the vehicle's ignition is powered off. The apparatus may determine whether to resume or initialize the above-described OTA update process, based on information collected by the second collection device 2002.

In other words, the second collection device 2002 according to embodiments may collect second information about the controller in response to interruption of the OTA update process. In particular, the second collection device 2002 may collect second information about the controller in response to interruption of the OTA update process and powering on the vehicle's ignition

The second information according to embodiments may be information for determining whether to replace the corresponding controller. The second information may include the identical or similar type of information to that of the first information. That is, the second information may also include at least one of VIN information of the vehicle or software version information. However, the first information and the second information may be collected in different periods.

The first information may be collected in a first period. The second information may be collected in a second period. The first period according to embodiments may precede the second period. In other words, even when the first information and the second information indicate the same type of information, the first information may be information collected before the second information.

That is, the first information may include at least one of first VIN information collected in the first period or first software version information collected in the first period. The second information may include at least one of second VIN information collected in the second period or second software version information collected in the second period. In other words, information collected in the first period may be referred to as “first VIN information” or “first software version information”. Information collected in the second period may be referred to as “second VIN information” or “second software version information”.

The replacement information generation device 2003 according to embodiments may generate replacement information of a controller, based on the collected first information and the collected second information.

The replacement information according to embodiments may indicate whether the above-described controller has been replaced. In detail, the replacement information may indicate whether a controller has been replaced during an interval between the first period and the second period. For example, the replacement information may include either information indicating that the controller has been replaced or information indicating that the controller has not been replaced.

The replacement information generation device 2003 may generate the above-described replacement information by comparing the first information and the second information. For example, the replacement information may include information indicating that the controller has not been replaced, in response to the first information being the same as the second information. Besides, the replacement information may include information indicating that the controller has been replaced, in response to the first information is different from the second information.

The process execution device 2004 according to embodiments may perform either a process of resuming an OTA update or a process of initializing a previously-performed OTA update on the controller based on the generated replacement information.

In other words, it is determined based on the replacement information that the controller has been replaced during an interval between the first period and the second period. In this case, when resuming the existing OTA update, an incorrect OTA update may be performed. As described above in FIG. 1, data intended in the existing OTA update may not be updated in the incorrect OTA update.

Accordingly, the process execution device 2004 may first perform a process of initializing the OTA update performed before the interruption, in response to the generated replacement information including information indicating that the controller has been replaced. Afterwards, the apparatus may again determine whether the replaced controller needs an OTA update. Afterward, when it is determined that there is a need for an OTA update, the apparatus may perform an OTA update on the controller.

When a condition (e.g., the ignition of a vehicle is powered on) of resuming an interrupted OTA update is satisfied, the apparatus according to embodiments may determine whether the controller, for which the interrupted OTA update is being performed, is replaced, through the method described in FIG. 2. Afterward, it is possible to efficiently perform a complete OTA update by performing different processes based on the determined replacement information.

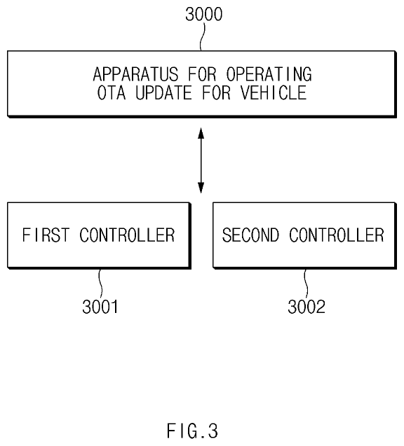

FIG. 3 illustrates an example of an OTA update performed by an OTA update apparatus 3000 (the apparatus described with reference to FIGS. 1 and 2) for a vehicle, according to embodiments.

As described above with reference to FIGS. 1 to 2, the apparatus according to embodiments may perform an OTA update of a controller. Furthermore, the apparatus may perform an OTA update on each controller.

The controller according to embodiments may indicate one of a first controller 3001 or a second controller 3002. The OTA update may be performed independently for the first controller 3001 or the second controller 3002. Accordingly, replacement information described above with reference to FIG. 2 may also be separately generated for the first controller 3001 or the second controller 3002.

The first controller may be a controller that mainly manages communication with the server described above in FIG. 1. The second controller may be a controller other than the first controller among controllers included in the vehicle. For example, the first controller may correspond to a central communication unit (CCU). The second controller may be a controller other than the CCU among controllers included in the vehicle.

Accordingly, replacement information of the first controller and the second controller may be generated in different manners. For example, the replacement information of the first controller may be generated based on first VIN information and second VIN information. In addition, replacement information of the second controller may be generated based on first software version information and second software version information.

When a condition (e.g., the ignition of a vehicle is powered on) of resuming an interrupted OTA update is satisfied, the apparatus according to embodiments may determine whether the controller, for which the interrupted OTA update is being performed, is replaced, through the method described in FIG. 3. Afterward, it is possible to efficiently perform a complete OTA update by performing different processes based on the determined replacement information.

In addition, the apparatus according to embodiments may determine replacement information about each controller in different manners for each attributes of controllers. Accordingly, the apparatus may generate replacement information for each controller and then may perform a process of resuming or initializing a more efficient OTA update.

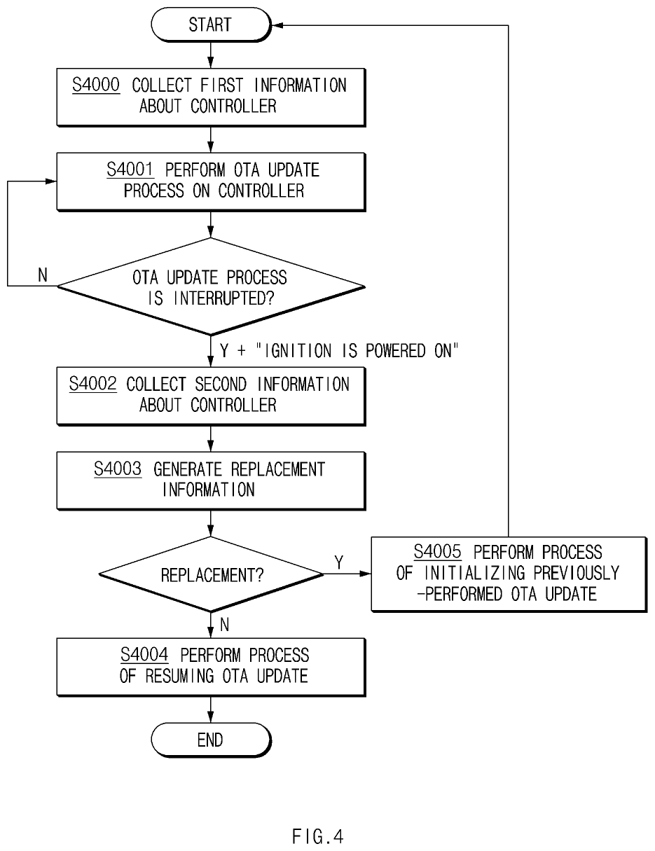

FIG. 4 illustrates an example of an OTA update method (or a method) for a vehicle, according to embodiments. The apparatus described above in FIGS. 1 to 3 may perform the method described in FIG. 4.

A first collection device (the first collection device in FIG. 2) according to embodiments may collect first information about a controller to perform an OTA update process for the controller (S4000). The description of the first information is the same as or similar to that described above with reference to FIGS. 2 and 3.

That is, the first collection device may collect the first information to determine whether to perform the OTA update process for the controller. As described above with reference to FIGS. 2 and 3, the first information may be used to generate replacement information of the corresponding controller.

Afterward, when it is determined to perform the OTA update process on the controller, a process execution device (the process execution device of FIG. 2) may perform an OTA update process on the controller (S4001).

As described above with reference to FIG. 2, the OTA update process of the controller may be interrupted. For example, because the vehicle's ignition is powered off, an OTA update process for the controller may be interrupted.

A second collection device (the second collection device in FIG. 2) according to embodiments may collect second information about the controller in response to interruption of the OTA update process (S4002). As described above with reference to FIG. 2, the second collection device may collect the second information about the controller in response to interruption of the OTA update process and powering on the vehicle's ignition. The description of the second information is the same as or similar to that described above with reference to FIGS. 2 and 3.

A replacement information generation device according to embodiments may generate replacement information of a controller, based on the collected first information and the collected second information (S4003). The detailed description of the replacement information is the same as or similar to that described above with reference to FIGS. 2 and 3.

A process execution device according to embodiments may perform a process of initializing the previously-performed OTA update in response to the replacement information including information indicating that the controller has been replaced (S4005). A detailed description of a process of initializing the previously-performed OTA update is the same as or similar to that described above with reference to FIGS. 2 to 3.

The process execution device according to embodiments may perform a process of resuming an OTA update in response to the replacement information including information indicating that the controller has not been replaced (S4004). A detailed description of the process of resuming the OTA update is the same as or similar to that described above with reference to FIGS. 2 to 3.

When a condition (e.g., the ignition of a vehicle is powered on) of resuming an interrupted OTA update is satisfied, the apparatus according to embodiments may determine whether the controller, for which the interrupted OTA update is being performed, is replaced, through the method described in FIG. 4. Afterward, it is possible to efficiently perform a complete OTA update by performing different processes based on the determined replacement information.

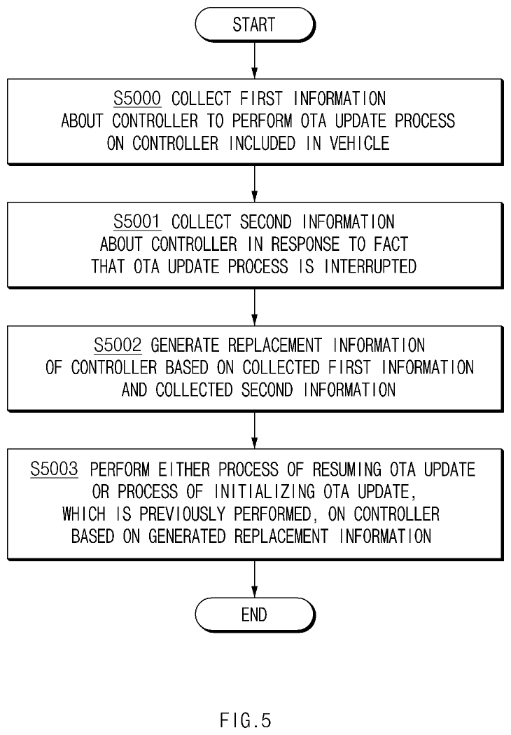

FIG. 5 illustrates an example of an OTA update method (or a method) for a vehicle, according to embodiments. A method described in FIG. 5 may be the same as or similar to the method described with reference to FIG. 4. An apparatus described in FIGS. 1 to 4 may perform a method described with reference to FIG. 6.

A method according to embodiments may include step S5000 of collecting first information about a controller to perform an OTA update process on the controller included in a vehicle, step S5001 of collecting second information about the controller in response to interruption of the OTA update process, step S5002 of generating replacement information of the controller based on the collected first information and the collected second information, and step S5003 of performing either a process of resuming the OTA update or a process of initializing the OTA update, which is previously performed, on the controller based on the generated replacement information.

A method according to embodiments may further include one or more steps not shown in FIG. 5.

The first information according to embodiments may be collected in a first period. The second information according to embodiments may be collected in a second period. The first period according to embodiments may precede the second period.

The OTA update process according to embodiments may be interrupted in response to powering off an ignition of the vehicle.

The second information according to embodiments may be collected in response to interruption of the OTA update process and powering off an ignition of the vehicle.

The first information according to embodiments may include at least one of first VIN information collected in the first period or first software version information collected in the first period. The second information according to embodiments may include at least one of second VIN information collected in the second period or second software version information collected in the second period.

The generated replacement information according to embodiments may include either information indicating that the controller has been replaced or information indicating that the controller has not been replaced.

Step S5003 according to embodiments includes performing a process of initializing the OTA update previously performed on the controller in response to the generated replacement information including information indicating that the controller has been replaced and performing a process of resuming the OTA update on the controller in response to the generated replacement information including information indicating that the controller has not been replaced.

The controller according to embodiments may indicate one of a first controller or a second controller.

According to embodiments, replacement information of the first controller may be generated based on the first VIN information and the second VIN information. According to embodiments, replacement information of the first controller may be generated based on the first software version information and the second software version information.

According to embodiments, the generated replacement information may include information indicating that the controller has not been replaced, in response to the first information being identical to the second information, and may include information indicating that the controller has been replaced, in response to the first information being different from the second information.

The detailed descriptions of the OTA update, the controller, the first information, the second information, the replacement information, the process of resuming the OTA update, the process of initializing the previously-performed OTA update, the first period, and the second period, which are described above, are the same as or similar to those described above with reference to FIGS. 1 to 4.

When a condition (e.g., the ignition of a vehicle is powered on) of resuming an interrupted OTA update is satisfied, the apparatus according to embodiments may determine whether the controller, for which the interrupted OTA update is being performed, is replaced, through the method described in FIG. 5. Afterward, it is possible to efficiently perform a complete OTA update by performing different processes based on the determined replacement information.

The above description is merely an example of the technical idea of the present disclosure, and various modifications and modifications may be made by one skilled in the art without departing from the essential characteristic of the present disclosure.

Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

According to embodiments, in resuming the interrupted OTA update, it is possible to determine whether a controller to be updated is replaced.

Moreover, according to embodiments, in resuming the interrupted OTA update, it is possible to initialize a previously-performed OTA update, when it is determined that the controller that is a target of an OTA update has been replaced.

Besides, a variety of effects directly or indirectly understood through the specification may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for performing an over-the-air (OTA) update for a vehicle, the apparatus comprising:
a first collection device configured to collect first information about a controller to perform an OTA update process on the controller included in the vehicle;
a second collection device configured to collect second information about the controller in response to interruption of the OTA update process;
a replacement information generation device configured to generate replacement information of the controller based on the collected first information and the collected second information; and
a process execution device configured to perform either a process of resuming the OTA update or a process of initializing the OTA update previously performed on the controller based on the generated replacement information.

2. The apparatus of claim 1, wherein the first information is collected in a first period,
wherein the second information is collected in a second period, and
wherein the first period precedes the second period.

3. The apparatus of claim 1, wherein the OTA update process is interrupted in response to powering off an ignition of the vehicle.

4. The apparatus of claim 1, wherein the second information is collected in response to interruption of the OTA update process and powering off an ignition of the vehicle.

5. The apparatus of claim 2, wherein the first information includes at least one of first vehicle identification number (VIN) information collected in the first period or first software version information collected in the first period, and
wherein the second information includes at least one of second VIN information collected in the second period or second software version information collected in the second period.

6. The apparatus of claim 1, wherein the generated replacement information includes either information indicating that the controller has been replaced or information indicating that the controller has not been replaced.

7. The apparatus of claim 6, wherein the process execution device performs the process of initializing the OTA update previously performed on the controller in response to the generated replacement information including information indicating that the controller has been replaced, and performs the process of resuming the OTA update on the controller in response to the generated replacement information including information indicating that the controller has not been replaced.

8. The apparatus of claim 5, wherein the controller indicates one of a first controller or a second controller.

9. The apparatus of claim 8, wherein replacement information of the first controller is generated based on the first VIN information and the second VIN information, and
wherein replacement information of the second controller is generated based on the first software version information and the second software version information.

10. The apparatus of claim 6, wherein the generated replacement information includes information indicating that the controller has not been replaced, in response to the first information being identical to the second information, and includes information indicating that the controller has been replaced, in response to the first information being different from the second information.

11. A method for performing an over-the-air (OTA) update for a vehicle, the method comprising:
collecting first information about a controller to perform an OTA update process on the controller included in the vehicle;
collecting second information about the controller in response to interruption of the OTA update process;
generating replacement information of the controller based on the collected first information and the collected second information; and
performing either a process of resuming the OTA update or a process of initializing the OTA update previously performed on the controller based on the generated replacement information.

12. The method of claim 11, wherein the first information is collected in a first period,
wherein the second information is collected in a second period, and
wherein the first period precedes the second period.

13. The method of claim 11, wherein the OTA update process is interrupted in response to powering off an ignition of the vehicle.

14. The method of claim 11, wherein the second information is collected in response to interruption of the OTA update process and powering off an ignition of the vehicle.

15. The method of claim 12, wherein the first information includes at least one of first VIN information collected in the first period or first software version information collected in the first period, and
wherein the second information includes at least one of second VIN information collected in the second period or second software version information collected in the second period.

16. The method of claim 11, wherein the generated replacement information includes either information indicating that the controller has been replaced or information indicating that the controller has not been replaced.

17. The method of claim 16, wherein the performing of either the process of resuming the OTA update or the process of initializing the OTA update previously performed on the controller includes:
performing the process of initializing the OTA update previously performed on the controller in response to the generated replacement information including information indicating that the controller has been replaced; and
performing the process of resuming the OTA update on the controller in response to the generated replacement information including information indicating that the controller has not been replaced.

18. The method of claim 15, wherein the controller indicates one of a first controller or a second controller.

19. The method of claim 18, wherein replacement information of the first controller is generated based on the first VIN information and the second VIN information, and
wherein replacement information of the second controller is generated based on the first software version information and the second software version information.

20. The method of claim 16, wherein the generated replacement information includes information indicating that the controller has not been replaced, in response to the first information being identical to the second information, and includes information indicating that the controller has been replaced, in response to the first information being different from the second information.
